(19) United States
(12) Patent Application Publication
(10) Pub. No.: US 2016/0317386 A1
(43) Pub. Date: Nov. 3, 2016

(54) Device for Administering Sustained Static Pressure and Force on Muscles

(71) Applicant: Georgette Constance Suttman, (US)

(72) Inventor: Georgette Constance Suttman, Houston, TX (US)

(21) Appl. No.: 13/875,246

(22) Filed: May 1, 2013

(51) Int. Cl. A61H 39/04; A61H 1/00

(52) U.S. Cl. CPC A61H 39/04; A61H 1/008

(57) ABSTRACT

Disclosed is a therapeutic sustained static pressure and force application device. The device may include a base member having at least one side with at least one hole and/or channel disposed therein. Further, the device may include at least one peg adapted to fit into the base member, wherein at least one peg fits into the base member in a predetermined pattern such that application of the device to an area of the human anatomy provides a therapeutic effect.

### BACKGROUND OF THE INVENTION

The present invention relates to therapeutic devices and, more particularly, to a device for administering sustained static pressure and force on muscles to soften, loosen, and rejuvenate tissue.

Muscles become tight, hard, stiff, and contracted due to over-use, excessive exercise and activity, repetitive motions, and a life time of usage. This results in limited range of motion, stiffness, pain, inflammation, and dysfunction.

Massage is a well-known therapy to enhance healing process, promoting relaxation and well-being. Typically, massage involves acting on and manipulating the body with pressure (structured, unstructured, stationary, or moving, such that forces are distributed against upper layers of muscles to increase the flow of blood. However, it was shown sustained static pressure and force provided a process of loosening and rehabilitation of muscles contracted after surgeries, stresses, injuries, and the like at a deeper layer of muscular tissue. It was demonstrated that sustained static pressure force techniques m ay help rehabilitate muscles and increase blood circulation.

Muscle rehabilitation for the above reasons and after injuries or operations with the help of sustained static pressure and force significantly increases general and local stimulation of muscles, tissues, and blood circulation throughout a human body. Sustained static pressure and force techniques may help improve these conditions, and rehabilitate injured and tight muscles.

Conventional devices accepted and administered in the health field are not accurately changing the tightness of the muscle. FIGS. 1-4, and 7A-12 show exemplary devices used to apply sustained static pressure and force to various body locations.

As can be seen, there is a need for a device that may administer sustained static pressure and force on muscles,

### BRIEF DESCRIPTION OF THE DRAWINGS

FIGS. 1-4 and 7A-12 are perspective views of a sustained static pressure and force application device according to exemplary embodiments of the present invention.

FIG. 5 is a schematic diagram showing a paddle design of a sustained static pressure and force application device according to another exemplary embodiment of the present invention.

FIG. 6 is a schematic diagram showing a design of a large full body sustained static pressure and force application device according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, hut is made merely for the purpose of illustrating the general principles of the invention, since the scope of the invention is best defined by the appended claims.

Broadly, an embodiment of the present invention provides a device that may reverse muscular tightness that results in nerve problems, limited range of motion and pain. The method of sustained static pressure and force administered on muscular tissue is the most effective way to soften, loosen, and rejuvenate them back into a healthy state. No other application has demonstrated the level of success. The device of the present invention provides an accurate and effective method to change a tight muscle into a loose muscle.

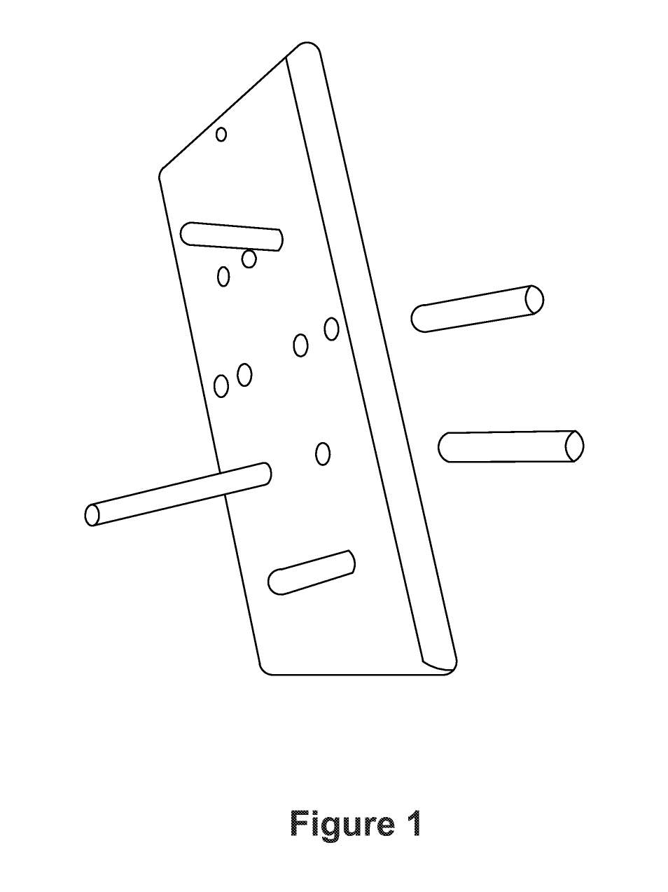

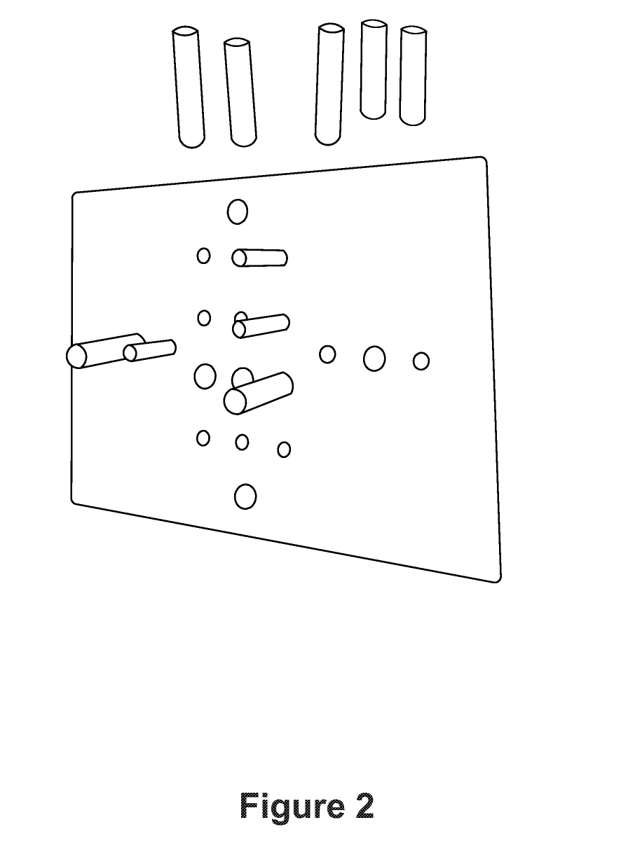

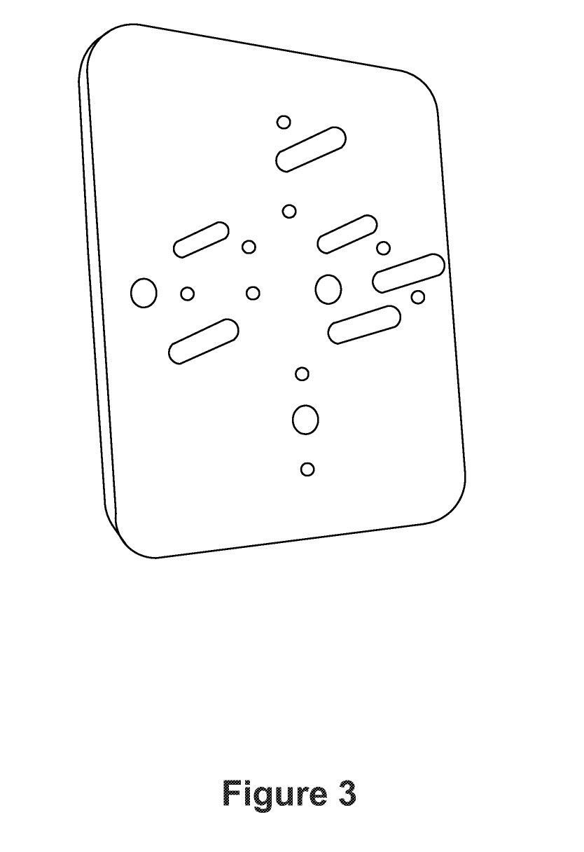

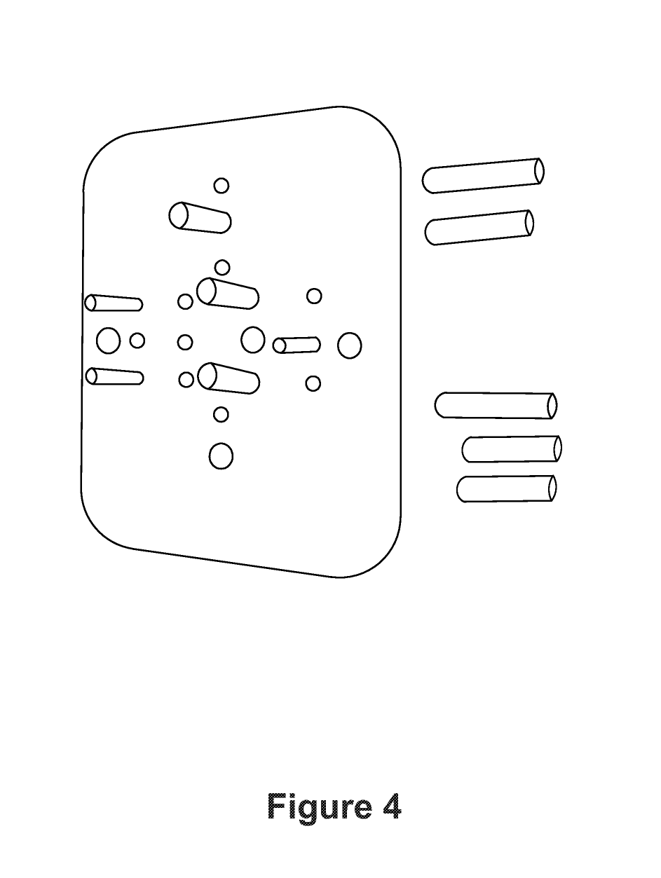

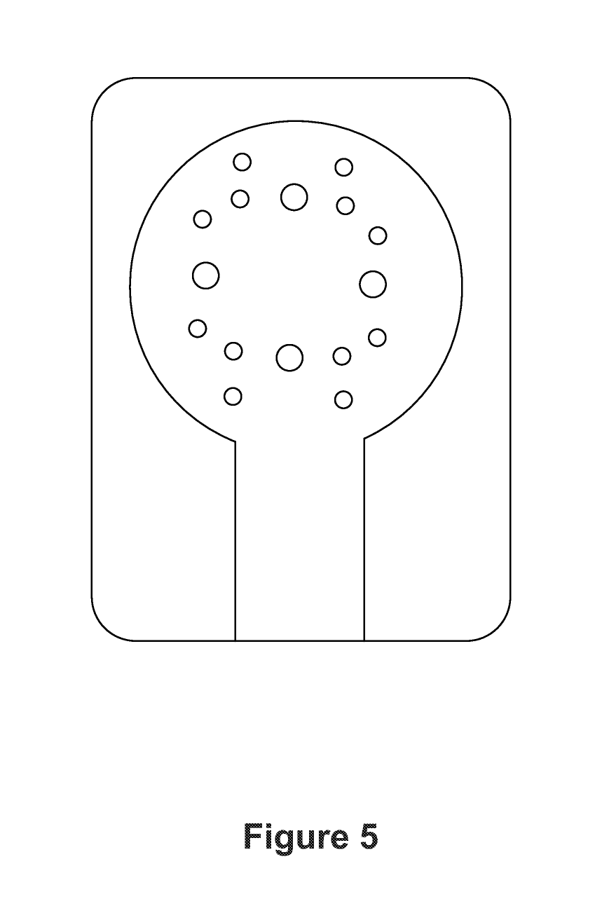

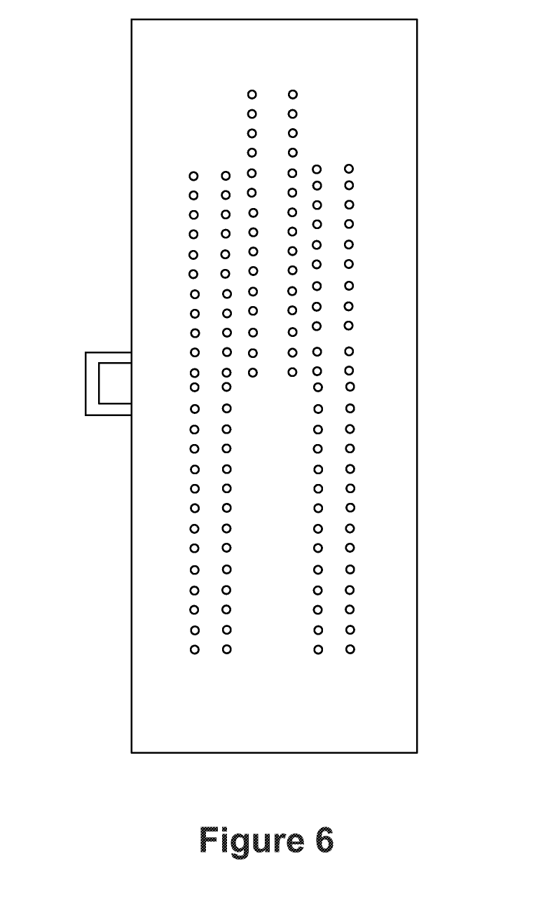

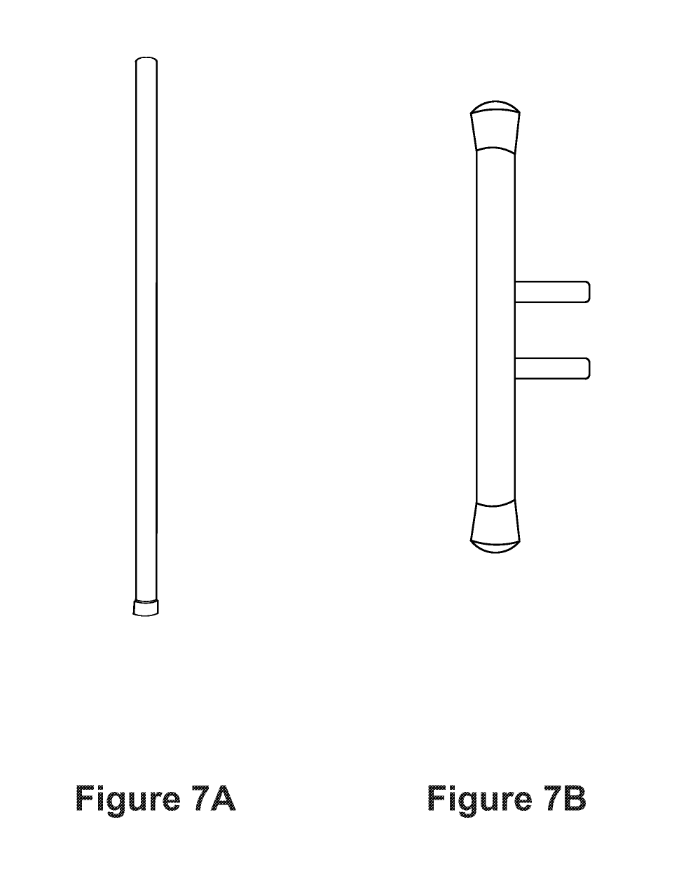

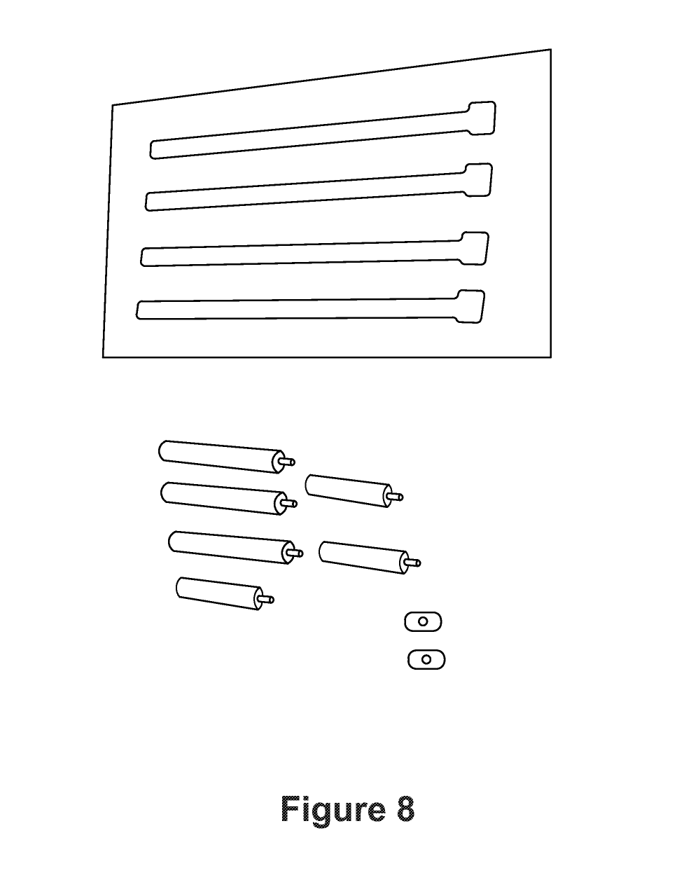

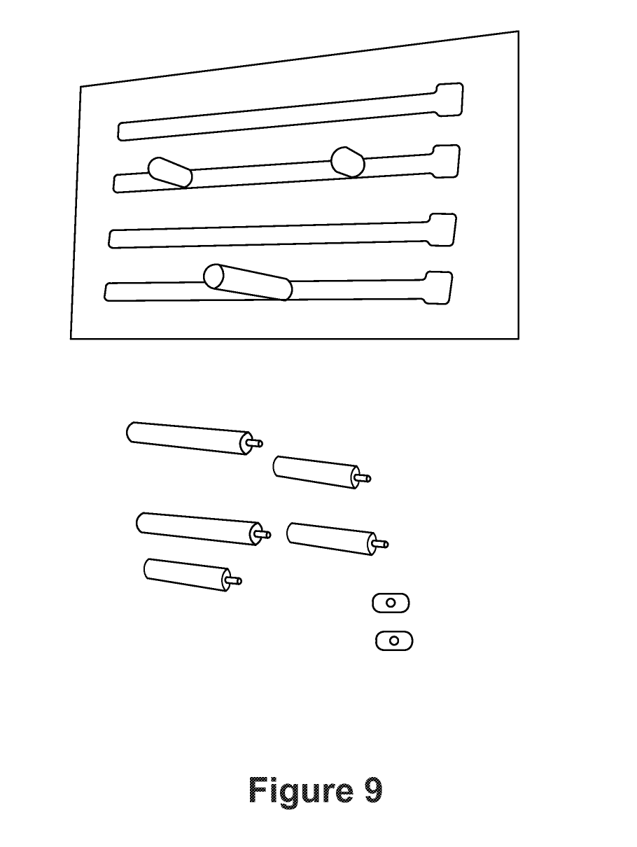

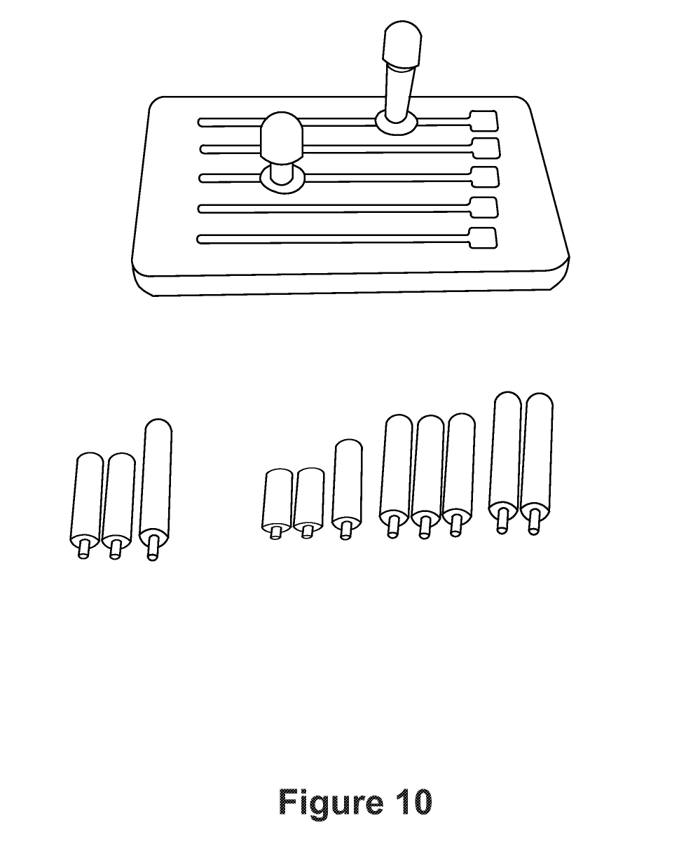

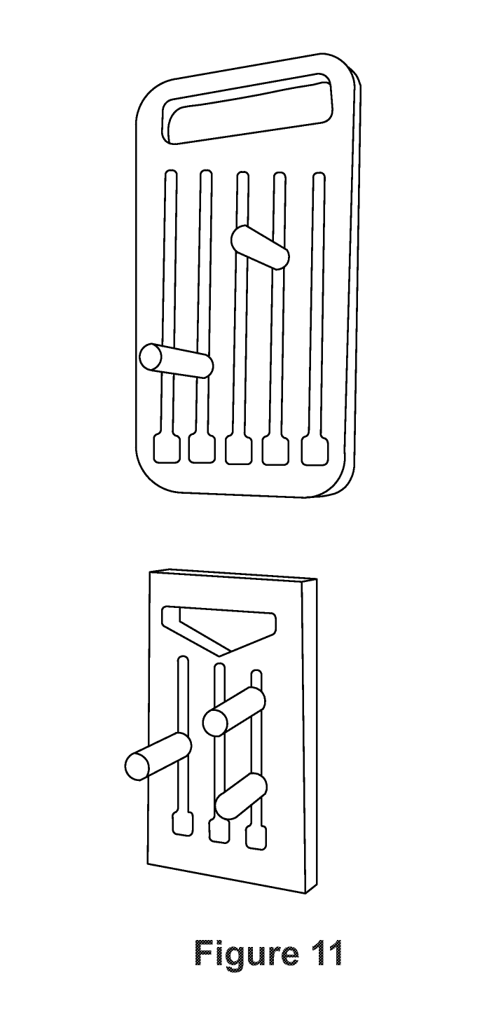

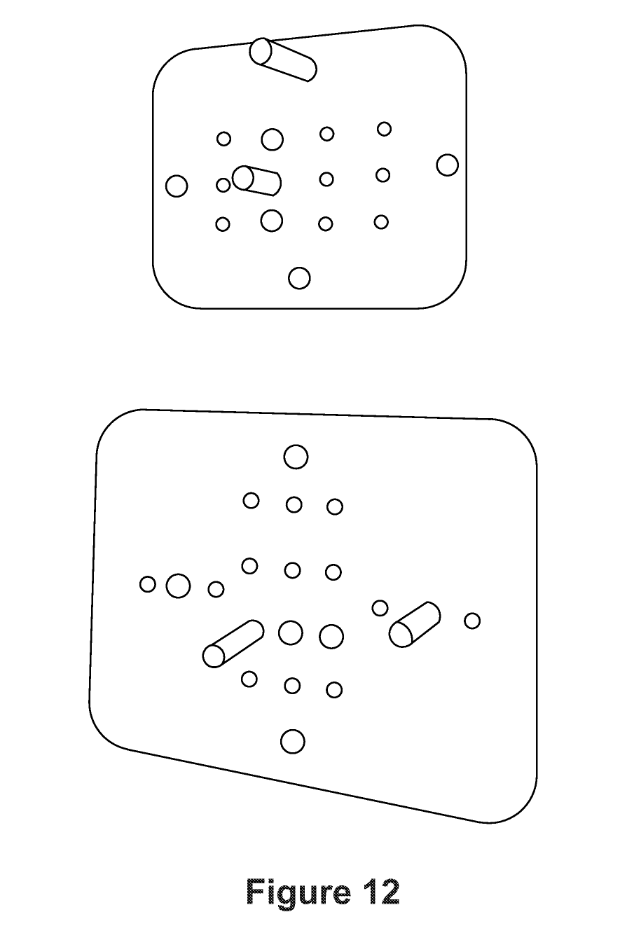

Referring now to FIGS. 1-4 and 7A-12, various embodiments of the present invention, with various applicators, called pegs, are shown. The pegs may be arranged and utilized in multiple manners, as described below, in order to achieve the desired results.

The device of the present invention may include a base member and one or a plurality of pegs. The base member may have a first generally planar side adapted to rest on a surface. A second, opposite, generally planar side may have a plurality of holes and/or channels drilled therein. Typically, the holes and/or channels extend partially through the base member, thereby preventing pegs inserted into the holes and/or channels from going all the way through the base member. The holes and/or channels may be arranged in various configurations, as shown in the Figures, for example. For example, the holes and/or channels may be arranged in a plurality of rows and columns, either aligned or not, depending upon the application. The holes and/or channels may be between about ½ inch and about 12 inches apart. Moreover, the side of the base may vary as well, depending upon the application. For example, aback muscle device, for example, may be significantly larger than a device adapted to work on the calf or foot.

A peg or pegs may be provided with the base member for insertion into appropriate holes and/or channels in the base member. The pegs may extend from about ½ inch to about 6 inches from the base member. The pegs may have a diameter from about 5/16 inch to about 1 inch, for example. The pegs may be designed to support portions or all of the human anatomy. Typically, the pegs are solid members; however, resiliently depressible pegs may be used such as pegs with an internal spring member, for example. Peg or pegs may also be attached to a T-nut assembly that slides back and forth the length of the channels.

The device and pegs of the present invention may he made from various materials, including, for example, wood, metal such as stainless steel, plastic such as high density polyethylene (HOPE), nylon, PVC, aluminum, composite, and the like.

The device of the present invention may be designed to support a portion and/or all of the human body on one or two rows or more with rows of one or more inline pegs attached to and extending from the base member. A doctor, chiropractor, therapist, or the like, may prescribe the use of the device of the present invention, indicating to the user the appropriate sized pegs and holes and/or channels to be used. The user may arrange the peg or pegs appropriately and rest the appropriate body portion atop the peg or pegs. The static sustained pressure and force from the device of the present invention may be administered, for example, from about one minute to about one hour, in one area or multiple areas.

It should be understood, of course, that the foregoing relates to exemplary embodiments of the invention and that modifications may be made without departing from the spirit and scope of the invention s set forth in the following claims.

What is claimed is:

1. A therapeutic sustained static pressure and force application device comprising:
a base member having at least one side with at least one hole and/or channel disposed therein; and
at least one peg adapted to fit into the base member, wherein
at least one peg fits into the base member in a predetermined pattern such that application of the device to an area of the human anatomy provides a therapeutic effect.
